(19) United States
(12) Patent Application Publication
(10) Pub. No.: US 2009/0197082 A1
(43) Pub. Date: Aug. 6, 2009

(54) Individually coated carbon nanotube wire-like structure related applications

(75) Inventors: Kai-Li Jiang, Beijing (CN); Liang Liu, Beijing (CN); Kai Liu, Beijing (CN); Qing-Yu Zhao, Beijing (CN); Yong-Chao Zhai, Beijing (CN); Shou-Shan Fan, Beijing (CN)

Correspondence Address: PCE INDUSTRY, INC.;ATT. Steven Reiss, 458 E. LAMBERT ROAD, FULLERTON, CA, 92835, US

(73) Assignees: Tsinghua University, Beijing City (CN); HON HAI Precision Industry CO., LTD., Tu-Cheng City, (TW)

(21) Appl. No.: 12/321,568

(22) Filed: Jan. 22, 2009

(30) Foreign Application Priority Data
Feb. 1, 2008 (CN) 200810066045.3

(51) Int. Cl. H01B 1/04; B32B 15/04

(52) U.S. Cl. 428/367; 252/502; 252/503; 977/742

(57) ABSTRACT

A individually coated carbon nanotube wire-like structure includes an amount of carbon nanotubes and a conductive coating on an outside surface of the carbon nanotubes. The carbon nanotubes are joined end-to-end by van der Waals attractive force therebetween.

### RELATED APPLICATIONS

This application is related to commonly-assigned applications entitled, “METHOD FOR MAKING COAXIAL CABLE” (Atty. Docket No. US19084); “COAXIAL CABLE” (Atty. Docket No. US19079); “METHOD FOR MAKING CARBON NANOTUBE TWISTED WIRE” (Atty. Docket No. US19083); “CARBON NANOTUBE COMPOSITE FILM” (Atty. Docket No. US19082); “METHOD FOR MAKING CARBON NANOTUBE FILM” (Atty. Docket No. US18899); “COAXIAL CABLE” (Atty. Docket No. US19092). The disclosures of the above-identified applications are incorporated herein by reference.

### BACKGROUND

1. Technical Field

The present disclosure relates to carbon nanotube-based composite materials, including an individually coated carbon nanotube wire-like structure.

2. Discussion of Related Art

Carbon nanotubes (CNTs) are a novel carbonaceous material and have received a great deal of interest since the early 1990s. Carbon nanotubes have interesting and potentially useful heat conducting, electrical conducting, and mechanical properties.

Fan et al. (Referring to “Spinning Continuous CNT Yarns, Nature, 2002, 419:801) disclosed a method for making a continuous carbon nanotube yam from a super-aligned carbon nanotube array. The carbon nanotube yam includes a plurality of carbon nanotube segments joined end to end and combined by van der Waals attractive therebetween. The carbon nanotube segments have an almost equal length. Each carbon nanotube segment includes a plurality of carbon nanotubes parallel with each other. However, since adjacent carbon nanotube segments have overlapping joints, the continuous carbon nanotube yam has a high resistance at the joints. Thus, continuous carbon nanotube yarn has a lower conductivity than related metal wire used.

What is needed, therefore, is a carbon nanotube wire-like structure and method for making the same, and the carbon nanotube wire-like structure has good conductivity, high mechanical performance, is lightweight, and has a small diameter, and the method is easy, suitable for low-cost and mass production.

### BRIEF DESCRIPTION OF THE DRAWINGS

Many aspects of the present carbon nanotube wire-like structure and method for making the same can be better understood with references to the accompanying drawings. The components in the drawings are not necessarily drawn to scale, the emphasis instead being placed upon clearly illustrating the principles of the present carbon nanotube wire-like structure and method for making the same.

FIG. 1 is a schematic section view of a individually coated carbon nanotube in the carbon nanotube wire-like structure, according to one embodiment.

FIG. 2 is a flow chart of a method for making the carbon nanotube wire-like structure of FIG. 1.

FIG. 3 is a system for making the carbon nanotube wire-like structure of FIG. 1.

FIG. 4 shows a Scanning Electron Microscope (SEM) image of a carbon nanotube film used in the method for making the carbon nanotube wire-like structure of FIG. 1.

FIG. 5 shows a Scanning Electron Microscope (SEM) image of the carbon nanotube film with at least one layer of conductive coating individually coated on each carbon nanotube therein used in the method for making the carbon nanotube wire-like structure of FIG. 1.

FIG. 6 shows a Transmission Electron Microscope (TEM) image of the carbon nanotube in the carbon nanotube film with at least one layer of conductive coating individually coated thereon of the carbon nanotube of FIG. 5.

FIG. 7 shows a Scanning Electron Microscope (SEM) image of a twisted carbon nanotube wire-like structure.

FIG. 8 shows a Scanning Electron Microscope (SEM) image of the carbon nanotubes with at least one layer of conductive coating individually coated thereon in the twisted carbon nanotube wire-like structure of FIG. 7.

Corresponding reference characters indicate corresponding parts throughout the several views. The exemplifications set out herein illustrate at least one embodiment of the present carbon nanotube wire-like structure and method for making the same, in at least one form, and such exemplifications are not to be construed as limiting the scope of the invention in any manner.

### DETAILED DESCRIPTION OF EXEMPLARY EMBODIMENTS

References will now be made to the drawings to describe, in detail, embodiments of the present carbon nanotube wire-like structure and method for making the same.

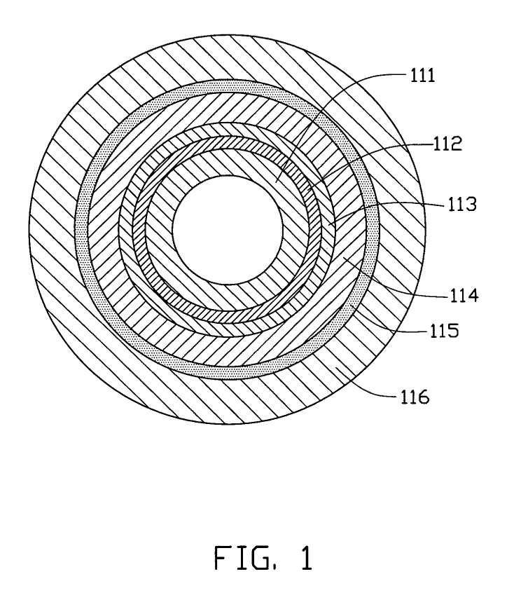

The carbon nanotube wire-like structure includes a plurality of carbon nanotubes 111 (as shown in FIG. 1) and at least one conductive coating on the outer surfaces of the individual carbon nanotubes. The one conductive coating comprises of at lease one conductive layer 114. The carbon nanotubes 111 are joined end-to-end by van der Waals attractive force therebetween and have a substantially equal length. The carbon nanotubes 111 can be aligned around the axis of the carbon nanotube wire-like structure like a helix. The carbon nanotubes 111 can also be arranged along an axis direction of the carbon nanotube wire-like structure (e.g., the axis of the carbon nanotubes are parallel to the axis of the non-twisted carbon nanotube wire). Further, the carbon nanotubes 111 are joined end to end by the van der Waals attractive force therebetween and can be organized into a free-standing carbon nanotube wire. The carbon nanotube wire can be twisted or non-twisted. The carbon nanotube wire-like structure includes the carbon nanotube wire and at least one conductive coating covered on the outside surface of each carbon nanotubes 111 in the carbon nanotube wire-like structure. A diameter of the carbon nanotube wire-like structure can range from about 4.5 nanometers to about 1 millimeter or even larger. In the present embodiment, the diameter of the carbon nanotube wire-like structure is in the range of about 1 micrometer to about 30 micrometers.

Referring to FIG. 1, each of the carbon nanotubes 111 in the carbon nanotube wire-like structure is covered by the at least one layer of conductive coating on the outer surface thereof. A conductive coating is in direct contact with the outer surface of the individual carbon nanotube 111. More specifically, the at least one layer of conductive coating further may include a wetting layer 112, a transition layer 113 and an anti-oxidation layer 115. As mentioned above, the conductive coating has at least one conductive layer 114. In the present embodiment, the conductive coating includes all of the aforementioned elements, the wetting layer 112 is the innermost layer, contactingly covers the surface of the carbon nanotube 111, and direct contact with the carbon nanotube 111. The transition layer 113 enwraps the wetting layer 112. The conductive layer 114 enwraps the transition layer 113. The anti-oxidation layer 115 enwraps the conductive layer 114.

Typically, wettability between carbon nanotubes and most kinds of metal is poor. The wetting layer 112 is configured to provide a good transition between the carbon nanotube 111 and the conductive layer 114. The material of the wetting layer 112 can be selected from the group consisting of iron (Fe), cobalt (Co), nickel (Ni), palladium (Pd), titanium (Ti), and alloys thereof. A thickness of the wetting layer 112 approximately ranges from 1 to 10 nanometers. In the present embodiment, the material of the wetting layer 112 is Ni and the thickness of the wetting layer 112 is about 2 nanometers. The use of a wetting layer is optional.

The transition layer 113 is arranged for combining the wetting layer 112 with the conductive layer 114. The material of the transition layer 113 can be copper (Cu), silver (Ag), and alloys thereof. A thickness of the transition layer 113 ranges from about 1 to about 10 nanometers. In the present embodiment, the material of the transition layer 113 is Cu and the thickness thereof is about 2 nanometers. The use of a transition layer is optional.

The conductive layer 114 is arranged for enhancing the conductivity of the carbon nanotube twisted wire. The material of the conductive layer 114 can be selected from any suitable conductive material including the group consisting of Cu, Ag, gold (Au) and alloys thereof. A thickness of the conductive layer 114 ranges from about 1 to about 20 nanometers. In the present embodiment, the material of the conductive layer 114 is Ag and the thickness thereof is about 10 nanometers.

The anti-oxidation layer 115 is configured to prevent the conducting layer 114 from being oxidized by exposure to the air and prevent reduction of the conductivity of the core 110. The material of the anti-oxidation layer 115 can be any suitable material including Au, platinum (Pt), and any other anti-oxidation metallic materials or alloys thereof. A thickness of the anti-oxidation layer 115 ranges from about 1 to about 10 nanometers. In the present embodiment, the material of the anti-oxidation layer 115 is Pt and the thickness is about 2 nanometers. The use of an anti-oxidation layer 115 is optional.

Furthermore, a strengthening layer 116 can be applied the outer surface of the layer of conductive coating to enhance the strength of the carbon nanotube wire-like structure. The material of the strengthening layer 116 can be any suitable material including a polymer with high strength, such as polyvinyl acetate (PVA), polyvinyl chloride (PVC), polyethylene (PE), or paraphenylene benzobisoxazole (PBO). A thickness of the strengthening layer 116 ranges from about 0.1 to about 1 micron. In the present embodiment, the strengthening layer 116 covers the anti-oxidation layer 115, the material of the strengthening layer 116 is PVA, and the thickness of the strengthening layer is about 0.5 microns. The use of a strengthening layer is optional

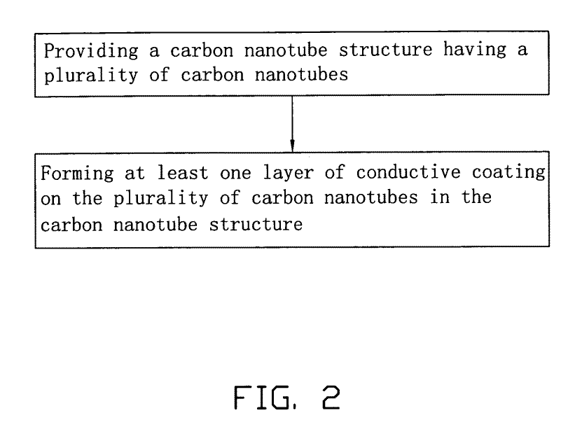

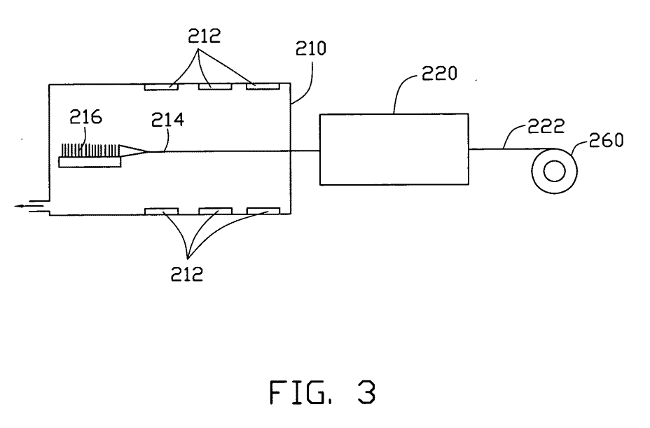

Referring to FIG. 2 and FIG. 3, a method for making the carbon nanotube wire-like structure 222 includes the following steps: (a) providing a carbon nanotube structure 214 having a plurality of carbon nanotubes; and (b) forming at least one layer of conductive coating on the plurality of carbon nanotubes in the carbon nanotube structure 214 to acquire a carbon nanotube wire-like structure 222.

In step (a), the carbon nanotube structure 214 can be a carbon nanotube film. Step (a) can include the following steps of: (a1) providing a carbon nanotube array 216 (e.g. a super-aligned carbon nanotube array); (a2) pulling out a carbon nanotube film from the carbon nanotube array 216 by using a tool (e.g., adhesive tape, pliers, tweezers, or another tool allowing multiple carbon nanotubes to be gripped and pulled simultaneously).

In step (a1), a super-aligned carbon nanotube array 216 can be provided and formed by the following substeps: (a11) providing a substantially flat and smooth substrate; (a12) forming a catalyst layer on the substrate; (a13) annealing the substrate with the catalyst layer in air at a temperature ranging from about 700° C. to about 900° C. for about 30 to 90 minutes; (a14) heating the substrate with the catalyst layer to a temperature ranging from about 500° C. to about 740° C. in a furnace with a protective gas in the furnace; and (a15) supplying a carbon source gas to the furnace for about 5 to about 30 minutes and growing the super-aligned carbon nanotube array 216 on the substrate.

In step (a11), the substrate can be a P-type silicon wafer, an N-type silicon wafer, or a silicon wafer with a film of silicon dioxide thereon. In the present embodiment, a 4-inch P-type silicon wafer is used as the substrate.

In step (a12), the catalyst can be made of iron (Fe), cobalt (Co), nickel (Ni), or any alloy comprising of iron (Fe), cobalt (Co), and nickel (Ni).

In step (a14), the protective gas can be made up of at least one of nitrogen (N₂), ammonia (NH₃), and a noble gas. In step (a5), the carbon source gas can be a hydrocarbon gas, such as ethylene (C₂H₄), methane (CH₄), acetylene (C₂H₂), ethane (C₂H₆), or any combination thereof.

The super-aligned carbon nanotube array 216 can be approximately 200 to 400 microns in height and include a plurality of carbon nanotubes parallel to each other and approximately perpendicular to the substrate. The carbon nanotubes in the carbon nanotube array 216 can be single-walled carbon nanotubes, double-walled carbon nanotubes, or multi-walled carbon nanotubes. Diameters of the single-walled carbon nanotubes range from about 0.5 nanometers to about 10 nanometers. Diameters of the double-walled carbon nanotubes range from about 1 nanometer to about 50 nanometers. Diameters of the multi-walled carbon nanotubes range from about 1.5 nanometers to about 50 nanometers.

The super-aligned carbon nanotube array 216 formed under the above conditions is essentially free of impurities such as carbonaceous or residual catalyst particles. The carbon nanotubes in the super-aligned carbon nanotube array 216 are closely packed together by van der Waals attractive force.

In step (a2), the carbon nanotube film can be formed by the following substeps: (a21) selecting a plurality of carbon nanotube segments having a predetermined width from the carbon nanotube array 216; and (a22) pulling the carbon nanotube segments at an even/uniform speed to achieve a uniform carbon nanotube film.

In step (a21), the carbon nanotube segments having a predetermined width can be selected by using a tool, such as an adhesive tape, to contact the carbon nanotube array 216. Each carbon nanotube segment includes a plurality of carbon nanotubes parallel to each other. In step (a22), the pulling direction is arbitrary (e.g., substantially perpendicular to the growing direction of the carbon nanotube array 216).

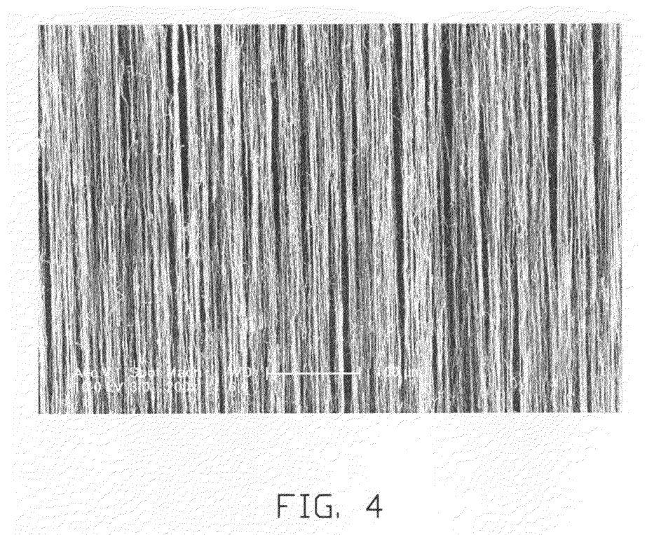

More specifically, during step (a22), because the initial carbon nanotube segments are drawn out, other carbon nanotube segments are also drawn out end-to-end due to the van der Waals attractive force between ends of adjacent segments. This process of drawing ensures that a continuous, uniform carbon nanotube film having a predetermined width can be formed. Referring to FIG. 4, the carbon nanotube film includes a plurality of carbon nanotubes joined end-to-end. The carbon nanotubes in the carbon nanotube film are all substantially parallel to the pulling/drawing direction of the carbon nanotube film, and the carbon nanotube film produced in such manner can be selectively formed to have a predetermined width. The carbon nanotube film formed by the pulling/drawing method has superior uniformity of thickness and conductivity over a typically disordered carbon nanotube film. Furthermore, the pulling/drawing method is simple, fast, and suitable for industrial applications.

The length and width of the carbon nanotube film depends on a size of the carbon nanotube array 216. When the substrate is a 4-inch P-type silicon wafer, as in the present embodiment, the width of the carbon nanotube film ranges from about 0.5 nanometers to about 10 centimeters, the length of the carbon nanotube film can be above 100 meters, and the thickness of the carbon nanotube film 216 ranges from about 0.5 nanometers to about 100 microns.

In step (b), the at least one conductive coating can be formed on the carbon nanotubes in carbon nanotube film by a physical vapor deposition (PVD) method such as a vacuum evaporation or a sputtering. In the present embodiment, the at least one conductive coating is formed by a vacuum evaporation method.

The vacuum evaporation method for forming the at least one conductive coating of step (b) can further include the following substeps: (b1) providing a vacuum container 210 including at least one vaporizing source 212; and (b2) heating the at least one vaporizing source 212 to deposit a conductive coating on two opposite surfaces of the carbon nanotube film.

The vacuum container 210 includes a depositing zone therein. In the present embodiment, three pairs of vaporizing sources 212 are respectively mounted on top and bottom portions of the depositing zone. Each pair of vaporizing sources 212 includes an upper vaporizing source 212 located on a top surface of the depositing zone, and a lower vaporizing source 212 located on a bottom surface of the depositing zone. The two vaporizing sources 212 are on opposite sides of the vacuum container 210. Each pair of vaporizing sources 212 is made of a type of metallic material. To vary the materials in different pairs of vaporizing sources 212, the wetting layer 112, the transition layer 113, the conductive layer 114, and the anti-oxidation layer 115 can be orderly formed on the carbon nanotubes in the carbon nanotube structure 214. The vaporizing sources 212 can be arranged along a pulling direction of the carbon nanotube structure 214 on the top and bottom portions of the depositing zone. The carbon nanotube structure 214 is located in the vacuum container 210 and between the upper vaporizing source 212 and the lower vaporizing source 212. There is a distance between the carbon nanotube structure 214 and the vaporizing sources 212. An upper surface of the carbon nanotube structure 214 directly faces the upper vaporizing sources 212. A lower surface of the carbon nanotube structure 214 directly faces the lower vaporizing sources 212. The vacuum container 210 can be vacuum-exhausted by using of a vacuum pump (not shown).

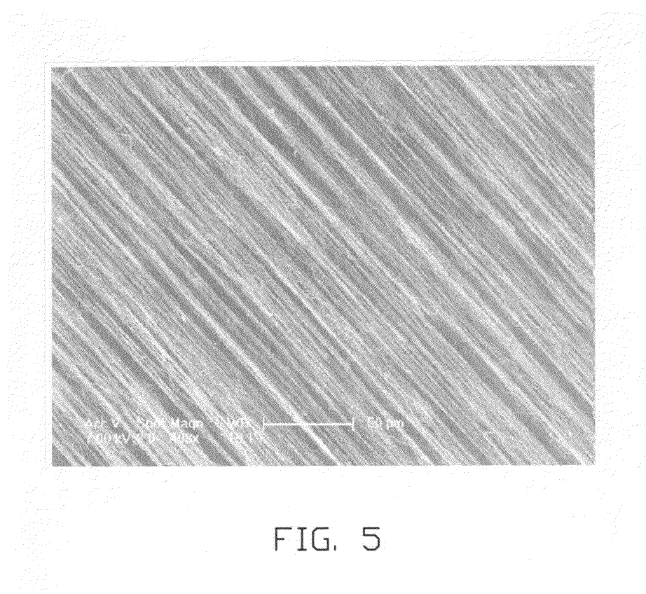

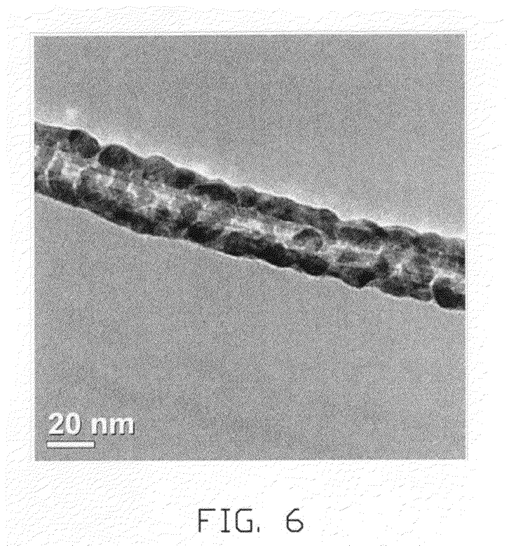

In step (b2), the vaporizing source 212 can be heated by a heating device (not shown). The material in the vaporizing source 212 is vaporized or sublimed to form a gas. The gas meets the cold carbon nanotubes in the carbon nanotube film and coagulates on the upper surface and the lower surface of carbon nanotubes in the carbon nanotube film. Due to a plurality of interspaces existing between the carbon nanotubes in the carbon nanotube film, in addition to the carbon nanotube film being relatively thin, the conductive material can be infiltrated in the interspaces in the carbon nanotube film between the carbon nanotubes. As such, the conductive material can be deposited on the outer surface of most, if not all, of the single carbon nanotubes. A microstructure of the carbon nanotube film with at least one conductive material thereon is shown in FIG. 5 and FIG. 6.

Each vaporizing source 212 can have a corresponding depositing area by adjusting the distance between the carbon nanotube film and the vaporizing sources 212. The vaporizing sources 212 can be heated simultaneously, while the carbon nanotube structure 214 is pulled through the multiple depositing zones between the vaporizing sources 212 to form multiple layers of conductive coatings.

To increase density of the gas in the depositing zone, and prevent oxidation of the conductive material, the vacuum degree in the vacuum container 210 is above 1 Pascal (Pa). In the present embodiment, the vacuum degree is about 4×10⁻⁴ Pa.

It is to be understood that the carbon nanotube array 216 formed in step (a1) can be directly placed in the vacuum container 210. The carbon nanotube film can be pulled in the vacuum container 210 and successively passed each vaporizing source 212, with each conductive coating continuously depositing thereon. Thus, the pulling step and the depositing step can be performed simultaneously.

In the present embodiment, the method for forming the at least one conductive coating includes the following steps: forming a wetting layer on a surface of the carbon nanotube film; forming a transition layer on the wetting layer; forming a conductive layer on the transition layer; and forming an anti-oxidation layer on the conductive layer. In the above-described method, the steps of forming the wetting layer, the transition layer, and the anti-oxidation layer are optional.

It is to be understood that the method for forming at least one conductive coating on each of the carbon nanotubes in the carbon nanotube structure 214 in step (b) can be a physical method such as vacuum evaporating or sputtering as described above, and can also be a chemical method such as electroplating or electroless plating. In the chemical method, the carbon nanotube structure 214 can be disposed in a chemical solution.

Step (b) further include forming a strengthening layer outside the at least one conductive coating. More specifically, the carbon nanotube film with the at least one conductive coating can be immersed in a container 220 with a liquid polymer. Thus, the entire surface and spaces between the carbon nanotube film can be soaked with the liquid polymer. After concentration (i.e., being cured), a strengthening layer can be formed on the outside of the individually coated carbon nanotubes.

Further, when the width of the individually coated carbon nanotube structure 214 is relatively large, an additionally step (c) of treating the individually coated carbon nanotube structure 214 with at least one conductive coating thereon can be further processed. In step (c), the individually coated carbon nanotube structure 214 with at least one conductive coating thereon can be treated with mechanical force (e.g., a conventional spinning process) to acquire a twisted carbon nanotube wire-like structure 222. The individually coated carbon nanotube structure 214 can be twisted along an aligned direction of the carbon nanotubes therein to acquire an individually coated and twisted carbon nanotube wire-like structure 222. The individually coated carbon nanotube structure 214 can also be cut along the aligned direction of the carbon nanotubes therein to acquire a non-twisted individually coated carbon nanotube wire-like structure 222.

In the present embodiment, step (c) can be executed by many methods. One method includes the following steps of: adhering one end of the individually coated carbon nanotube structure 214 to a rotating motor; and twisting the individually coated carbon nanotube structure 214 by the rotating motor. Another method includes the following steps of: supplying a spinning axis; contacting the spinning axis to one end of the individually coated carbon nanotube structure 214; and twisting the individually coated carbon nanotube structure 214 by the spinning axis.

A plurality of carbon nanotube wire-like structures 222 can be stacked or twisted to form one carbon nanotube wire-like structure 222 with a larger diameter. A plurality of coated carbon nanotube structures 214 can be arranged parallel to each other and then twisted to form the carbon nanotube wire-like structure with the large diameter. Also two or more coated carbon nanotube structures 214 can be stacked and then twisted to form the carbon nanotube wire-like structure with the large diameter. In one embodiment, about 500 layers of carbon nanotube films are stacked with each other and twisted to form a carbon nanotube wire-like structure 222 whose diameter can reach 3 millimeters.

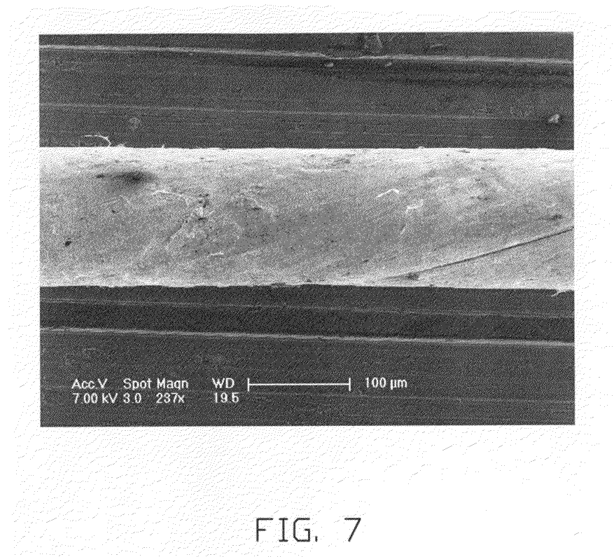

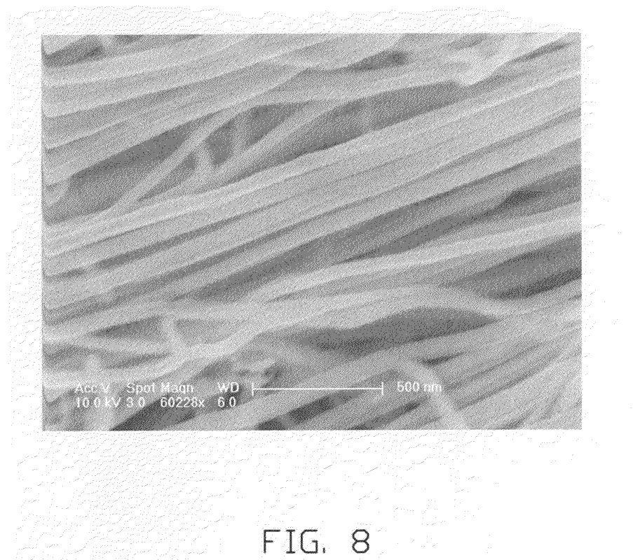

An SEM image of a twisted carbon nanotube wire-like structure 222 can be seen in FIGS. 7 and 8, and includes a plurality of carbon nanotubes with at least one conductive material on the carbon nanotubes and oriented along an axis of the carbon nanotube wire-like structure 222 (i.e., carbon nanotubes are aligned around the axis of carbon nanotube wire-like structure 222 like a helix). Each carbon nanotubes in the carbon nanotube wire-like structure 222 are covered by the conductive coating. The carbon nanotube wire-like structure 222 can be further collected by a roller 260 by coiling the carbon nanotube wire-like structure 222 onto the roller 260.

To acquire the non-twisted carbon nanotube wire-like structure 222, in step (c), the individually coated carbon nanotube structure 214 can be cut along the pulling direction of the individually coated carbon nanotube structure 214 (i.e., the aligned direction of the carbon nanotubes in the individually coated carbon nanotube structure 214) to form several individually coated non-twisted carbon nanotube wire-like structures 222 which have narrower widths than that of the original individually coated carbon nanotube structure 214.

It is to be noted that, after the cutting step, the non-twisted carbon nanotube wire-like structure 222 can be twisted to form the twisted carbon nanotube wire-like structure 222.

Further, the steps of forming the carbon nanotube film, the at least one conductive coating, and the strengthening layer can be processed in a same vacuum container to achieve a continuous production of the carbon nanotube wire-like structure 222.

The conductivity of the carbon nanotube wire-like structure 222 is better than the conductivity of the carbon nanotube structure 214. The resistivity of the carbon nanotube wire-like structure 222 can be ranged from about 10×10⁻⁸ Ω·m to about 500×10⁻⁸ Ω·m. In the present embodiment, the carbon nanotube wire-like structure 222 has a diameter of about 120 microns, and a resistivity of about 360×10⁻⁸ Ω·m. The resistivity of the carbon nanotube structure 214 without conductive coating is about 1×10⁻⁵ Ω·m˜2×10⁻⁵ Ω·m.

The carbon nanotube wire-like structure 222 provided in the present embodiment has the following superior properties: Firstly, the carbon nanotube wire-like structure 222 includes a plurality of oriented carbon nanotubes joined end-to-end by van der Waals attractive force. Thus, the carbon nanotube wire-like structure 222 has high strength and toughness. Secondly, the outer surface of each carbon nanotube is covered by at least one conductive coating. Thus, the individually coated carbon nanotube wire-like structure 222 has high conductivity. Thirdly, the method for forming the individually coated carbon nanotube wire-like structure 222 is simple and relatively inexpensive. Additionally, the carbon nanotube wire-like structure 222 can be formed continuously and, thus, a mass production of the carbon nanotube wire-like structure 222 can be achieved. Fourthly, since the carbon nanotubes have a small diameter, the carbon nanotube wire-like structure 222 includes a plurality of carbon nanotubes and at least one conductive coating thereon, thus the carbon nanotube wire-like structure 222 has a smaller width than a metal wire formed by a conventional method and can be used in ultra-fine cables. Finally, since the carbon nanotubes are hollow, and a thickness of the at least one layer of the conductive material is just several nanometers, thus a skin effect is less likely to occur in the carbon nanotube wire-like structure 222, and signals will not decay as much during transmission.

It is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

It is also to be understood that the above description and the claims drawn to a method may include some indication in reference to certain steps. However, the indication used is only to be viewed for identification purposes and not as a suggestion as to an order for the steps.

What is claimed is:

1. An individually coated carbon nanotube wire-like structure comprising:
a plurality of carbon nanotubes are joined end-to-end by van der Waals attractive force therebetween; and
at least one conductive coating disposed about the carbon nanotubes.

2. The individually coated carbon nanotube wire-like structure as claimed in claim 1, wherein the conductive coating is in contact with the surfaces of the carbon nanotubes.

3. The individually coated carbon nanotube wire-like structure as claimed in claim 2, further comprising an axial direction and wherein the carbon nanotubes are aligned along the axial direction.

4. The individually coated carbon nanotube wire-like structure as claimed in claim 2, wherein the carbon nanotubes are helically aligned around the axial direction of the carbon nanotube wire-like structure.

5. The individually coated carbon nanotube wire-like structure as claimed in claim 1, further comprising a diameter in the range about 4.5 nanometers to about 1 millimeter.

6. The individually coated carbon nanotube wire-like structure as claimed in claim 1, wherein the conductive coating comprises a conductive layer.

7. The individually coated carbon nanotube wire-like structure as claimed in claim 6, wherein the material of the conductive layer comprises of a material selected from the group consisting of copper, silver, gold and alloys thereof.

8. The individually coated carbon nanotube wire-like structure as claimed in claim 6, wherein a thickness of the conductive layer is in the range from about 1 to about 20 nanometers.

9. The individually coated carbon nanotube wire-like structure as claimed in claim 6, wherein the conductive coating further comprises a wetting layer, the wetting layer is located between the outside surface of the individual carbon nanotube and the conductive layer.

10. The individually coated carbon nanotube wire-like structure as claimed in claim 9, wherein the material of the wetting layer comprises of a material selected from the group consisting of iron, cobalt, nickel, palladium, titanium, and alloys thereof.

11. The individually coated carbon nanotube wire-like structure as claimed in claim 9, wherein a thickness of the wetting layer ranges from about 1 to about 10 nanometers.

12. The individually coated carbon nanotube wire-like structure as claimed in claim 9, wherein the conductive coating further comprises a transition layer between the wetting layer and the conductive layer.

13. The individually coated carbon nanotube wire-like structure as claimed in claim 12, wherein the material of the transition layer comprises of a material selected from the group consisting of copper, silver and alloys thereof.

14. The individually coated carbon nanotube wire-like structure as claimed in claim 12, wherein a thickness of the transition layer ranges from about 1 to about 10 nanometers.

15. The individually coated carbon nanotube wire-like structure as claimed in claim 6, wherein the conductive coating further comprises an anti-oxidation layer about the conductive layer.

16. The individually coated carbon nanotube wire-like structure as claimed in claim 15, wherein the material of the anti-oxidation layer comprised of a material selected from the group consisting gold, platinum and alloys thereof.

17. The individually coated carbon nanotube wire-like structure as claimed in claim 15, wherein a thickness of the anti-oxidation layer is in the range from about 1 to about 10 nanometers.

18. The individually coated carbon nanotube wire-like structure as claimed in claim 1, further comprising a strengthening layer outside the conductive coating.

19. The individually coated carbon nanotube wire-like structure as claimed in claim 18, wherein a thickness of the strengthening layer ranges from about 0.1 to about 1 micron.

20. A individually coated carbon nanotube wire-like structure comprising:
at least one carbon nanotube wire comprising a plurality of carbon nanotubes;
at least a conductive coating in contact with the surface of the individual carbon nanotubes.
